(19) United States
(12) Patent Application Publication
(10) Pub. No.: US 2013/0312478 A1
(43) Pub. Date: Nov. 28, 2013

(54) METHOD OF MANUFACTURING HOT PRESSED PRODUCT AND HOT PRESSING APPARATUS

(71) Applicant: TOPRE CORPORATION, TOKYO (JP)

(72) Inventor: MASANORI KOBAYASHI, KANAGAWA (JP)

(73) Assignee: TOPRE CORPORATION, Tokyo (JP)

(21) Appl. No.: 13/889,651

(22) Filed: May 8, 2013

(30) Foreign Application Priority Data
May 28, 2012 (JP) 2012120506

(51) Int. Cl. H05B 6/10; B21D 37/16

(52) U.S. Cl. CPC H05B 6/101; B21D 37/16
USPC 72/342.6; 219/645; 219/653

(57) ABSTRACT

Provided is a method of manufacturing a hot pressed product with which a heating coil of the induction heating device is moved in a feeding direction of the metal strip and in a direction opposite to the feeding direction of the metal strip so as to reduce variation in a feed velocity of the metal strip relative to the heating coil of the induction heating device.

### CROSS-REFERENCE TO RELATED APPLICATION

The present application claims priority from Japanese Patent Application No. 2012-120506 filed on May 28, 2012, the contents of which are hereby incorporated by reference into this application.

### BACKGROUND OF THE INVENTION

1. Field of the Invention

The present invention relates to a method of manufacturing a hot pressed product and to a hot pressing apparatus, and, in particular, to such a method and an apparatus with which a metal strip is heated using an induction heating device and is hot pressed.

2. Description of the Related Art

There are known progressive pressing methods in which a strip-shaped metal sheet (metal strip) is heated using a high-frequency heating device before progressively pressing the metal strip (see, for example, Japanese Unexamined Patent Application Publication No. 2002-346653l ).

There are known induction heating devices that heat an article to be heated to a target temperature while controlling electric power in proportion to the feed velocity of the article to be heated (see, for example, Japanese Unexamined Patent Application Publication No. 57-157482).

There are known induction heating methods in which a movable induction heating coil is used and a metal material is preheated for a predetermined time while maintaining a state in which an end portion of the metal material and the induction heating coil do not move relative to each other (see, for example, Japanese Unexamined Patent Application Publication No. 53-17509).

In a progressive pressing process, the velocity of a material (a metal strip) varies widely, because the metal strip is intermittently fed. Therefore, it is difficult to heat the metal strip to a uniform temperature using a high-frequency induction heating device. As a result, a problem occurs in that the temperature of the metal strip may become uneven.

Moreover, it is difficult to heat the metal strip to a uniform temperature by controlling electric power supplied to a heating coil of an induction heating device, because the velocity of the metal strip varies widely in a progressive pressing process. As a result, a problem occurs in that the temperature of the metal strip may become uneven.

Furthermore, it is difficult to heat the metal strip to a uniform temperature by using a mechanism with which the metal strip does not move relative to a heating coil of an induction heating device. As a result, a problem occurs in that the temperature of a portion of the metal strip positioned at an end of the heating coil may become uneven.

If the temperature of a metal strip becomes uneven, the metal strip may become deformed and may cause a feeding failure. Moreover, hot pressed products may be formed from the metal strip with low precision.

Accordingly, it is an object of the present invention to provide a method of manufacturing a hot pressed product and a hot pressing apparatus with which a metal strip is heated using an induction heating device and the heated metal strip is progressively pressed and with which occurrence of uneven temperature of the metal strip can be prevented.

### SUMMARY OF THE INVENTION

According to a first aspect of the invention, a method of manufacturing a hot pressed product includes heating a metal strip using an induction heating device, and progressively pressing the heated metal strip. In the method, a heating coil of the induction heating device is moved in a feeding direction of the metal strip and in a direction opposite to the feeding direction of the metal strip so as to reduce variation in a feed velocity of the metal strip relative to the heating coil of the induction heating device.

In the method, when the metal strip is being fed, the heating coil of the induction heating device may heat the metal strip while moving at a first moving velocity in a direction the same as a moving direction of the metal strip. The first moving velocity is lower than a moving velocity of the metal strip, and the difference between the moving velocity of the metal strip and the first moving velocity is constant. When the metal strip is not moving, the heating coil of the induction heating device may heat the metal strip while moving at a second moving velocity in a direction opposite to the moving direction of the metal strip. The second moving velocity is the same as the difference between the moving velocity of the metal strip and the first moving velocity.

According to a second aspect of the invention, a hot pressing apparatus includes an induction heating device that heats a metal strip, a progressive pressing device that progressively presses the metal strip, and a heating coil moving unit that moves a heating coil of the induction heating device in a feeding direction of the metal strip and in a direction opposite to the feeding direction of the metal strip so as to reduce variation in a feed velocity of the metal strip relative to the heating coil of the induction heating device.

In the hot pressing apparatus, when the progressive pressing device is feeding the metal strip, the heating coil moving unit may move the heating coil of the induction heating device at a first moving velocity in a direction the same as a moving direction of the metal strip in which the metal strip is moved by the progressive pressing device. The first moving velocity is lower than a moving velocity of the metal strip at which the metal strip is moved by the progressive pressing device, and the difference between the moving velocity of the metal strip and the first moving velocity being constant. When the progressive pressing device is not moving the metal strip and the progressive pressing device is press-forming the metal strip, the heating coil moving unit may move the heating coil of the induction heating device at a second moving velocity in a direction opposite to the moving direction of the metal strip. The second moving velocity is the same as the difference between the moving velocity of the metal strip and the first moving velocity.

The present invention has an advantage in that, with a method and an apparatus for manufacturing a hot pressed product with which a metal strip is heated using an induction heating device and the heated metal strip is progressively pressed, occurrence of uneven temperature of the metal strip can be reduced or prevented.

### BRIEF DESCRIPTION OF THE DRAWINGS

FIG. 1 is schematic view of a hot pressing apparatus according to an embodiment of the present invention; and

FIG. 2 is a diagram illustrating motion of a metal strip and motion of a heating coil of the hot pressing apparatus according to the embodiment of the present invention.

### DETAILED DESCRIPTION

With a method of manufacturing a hot pressed product 3 (hot press-formed product) according to an embodiment of the present invention, the hot pressed product 3 is obtained by heating a metal strip 1 (made of a material such as a high-tensile steel or the like) using an induction heating device 11, and by progressive pressing the heated metal strip 1. That is, in the method of manufacturing the hot pressed product 3, the metal strip 1 is heated using a heating coil 5 of the induction heating device 11 while the metal strip 1 is intermittently fed (in other words, moved, or conveyed) in the longitudinal direction of the metal strip 1, and the heated metal strip 1 is press-formed using a die 7 (7A and 7B).

Moreover, in the method of manufacturing the hot pressed product 3, in order to reduce variation in the feed velocity (moving velocity) of the metal strip 1 relative to the heating coil 5 of the induction heating device 11, the heating coil 5 of the induction heating device 11 is moved alternately in the feeding direction of the metal strip 1 and in a direction opposite to the feeding direction of the metal strip 1.

By reducing variation in the feed velocity (moving velocity) of the metal strip 1 relative to the heating coil 5, uneven heating by the heating coil 5 of the induction heating device 11 (in particular, uneven heating in the longitudinal direction of the metal strip 1) is reduced or prevented. As a result, the temperatures of any portions of the metal strip 1 heated by the induction heating device 11 become generally the same.

In the method of manufacturing the hot pressed product 3, the metal strip 1 is press-formed when the metal strip 1 is not moving (when the metal strip 1 is not moving relative to the die 7 in the feeding direction of the metal strip 1). When the metal strip 1 is being fed (is moving), the metal strip 1 (to be precise, a predetermined portion of the metal strip 1) is heated using the heating coil 5 of the induction heating device 11 while moving the heating coil 5 at a first moving velocity (first velocity).

The direction of the first moving velocity of the heating coil 5 is substantially the same as that of the moving velocity of the metal strip 1. The magnitude of the first moving velocity of the heating coil 5 is lower than that of the moving velocity of the metal strip 1. The difference between the moving velocity of the metal strip 1 and the first moving velocity of the heating coil 5 is substantially constant.

When the metal strip 1 is not moving, the metal strip 1 (to be precise, a predetermined portion of the metal strip 1) is heated using the heating coil 5 of the induction heating device 11 while moving the heating coil 5 at a second moving velocity (second velocity).

The direction of the second moving velocity of the heating coil 5 is opposite to that of the moving velocity of the metal strip 1 when the metal strip 1 is moving. The magnitude of the second moving velocity of the heating coil 5 is substantially the same as the difference between the moving velocity of the metal strip 1 when the metal strip 1 is moving and the first moving velocity.

Next, a hot pressing apparatus 9 for performing the method of manufacturing the hot pressed product 3 will be described. The hot pressing apparatus 9 (for manufacturing the hot pressed product 3) is an example of an apparatus for performing the method of manufacturing the hot pressed product 3, although other apparatuses and methods may be used.

For convenience of description, the longitudinal direction of the metal strip 1 will be referred to as the X-axis direction, a direction perpendicular to the X-axis direction will be referred to as the Y-axis direction, and a direction perpendicular to the X-axis direction and the Y-axis direction will be referred to as the Z-axis direction (up-down direction).

The hot pressing apparatus 9 includes the induction heating device 11 that heats the metal strip 1, a progressive pressing device 13 that progressively presses the metal strip 1, and a heating coil moving unit 15.

The progressive pressing device 13 includes a metal strip feeding unit 17 that intermittently feeds the metal strip 1 in the longitudinal direction of the metal strip 1 (the direction of arrow A6), and a die driving unit 19 that drives the die 7 for press-forming the metal strip 1.

The die driving unit 19 appropriately moves an upper die 7A of the die 7 in the direction of arrow A4 (Z-axis direction), so that the metal strip 1 is press-formed.

The heating coil moving unit 15 moves the heating coil 5 of the induction heating device 11 in the feeding direction of the metal strip 1 (that is, the direction of arrow A7, or the positive X-axis direction) and in a direction opposite to the feeding direction of the metal strip 1 (that is, the direction of arrow A8, or the negative X-axis direction) in order to reduce variation in the feed velocity of the metal strip 1 relative to the heating coil 5 of the induction heating device 11 as described above.

In one non-limiting embodiment, the heating coil 5 of the induction heating device 11 has a helical shape. The metal strip 1 extends through the heating coil 5. The heating coil 5 of the induction heating device 11, which heats the metal strip 1 by induction, is disposed upstream (in the negative X-axis direction) of the die 7 in the feeding direction of the metal strip 1 so as to be separated from the die 7, which is driven by the die driving unit 19 of the progressive pressing device 13.

The metal strip feeding unit 17 will be described further. For example, a roll 25 of the metal strip 1 is disposed at the upstream end in the feeding direction. The metal strip 1 extends in the X-axis direction through the metal strip feeding unit 17, through the heating coil 5, and through the die 7. In this extending state, the width direction of the metal strip 1 corresponds to the Y-axis direction, and the thickness direction of the metal strip 1 corresponds to the Z-axis direction. The metal strip 1 is intermittently moved when the metal strip feeding unit 17, which is disposed between the roll 25 and the heating coil 5, is driven.

A metal material to be press-formed (metal strip 1) is wound in the roll 25 on the upstream side. The metal strip 1 on the downstream side (from which the hot pressed product 3 has been removed) is cut into short pieces at an end of the die 7 and is discharged as scrap.

The metal strip feeding unit 17 includes, for example, a pair of clampers 21. The pair of clampers 21 are moved by an actuator (not shown) in the direction of arrow Al (Z-axis direction) to hold the metal strip 1 or to release the metal strip 1.

Moreover, the pair of clampers 21 are moved by an actuator (not shown) in the direction of arrow A3 (X-axis direction).

The pair of clampers 21 are moved appropriately, so that the metal strip 1 is intermittently moved in the positive X-axis direction.

After the hot pressed product 3 has been hot pressed using the die 7, the hot pressed product 3 is removed from the metal strip 1. The hot pressed product 3, which has been removed from the metal strip 1, is placed in a water bath 23 or sprinkled with water to be quenched.

As can be understood from the above description, the heating coil 5 of the induction heating device 11 and the die 7 for press-forming the metal strip 1 are disposed downstream of the roll 25 and the clampers 21 (metal strip feeding unit 17) in the feeding direction of the metal strip 1. The heating coil 5 is disposed upstream of the die 7 in the feeding direction of the metal strip 1. After the metal strip 1 has been heated by the heating coil 5 to a temperature that is higher than the Ac₃ transformation point (for example, about 900° C.), the metal strip 1 is hot pressed using the die 7.

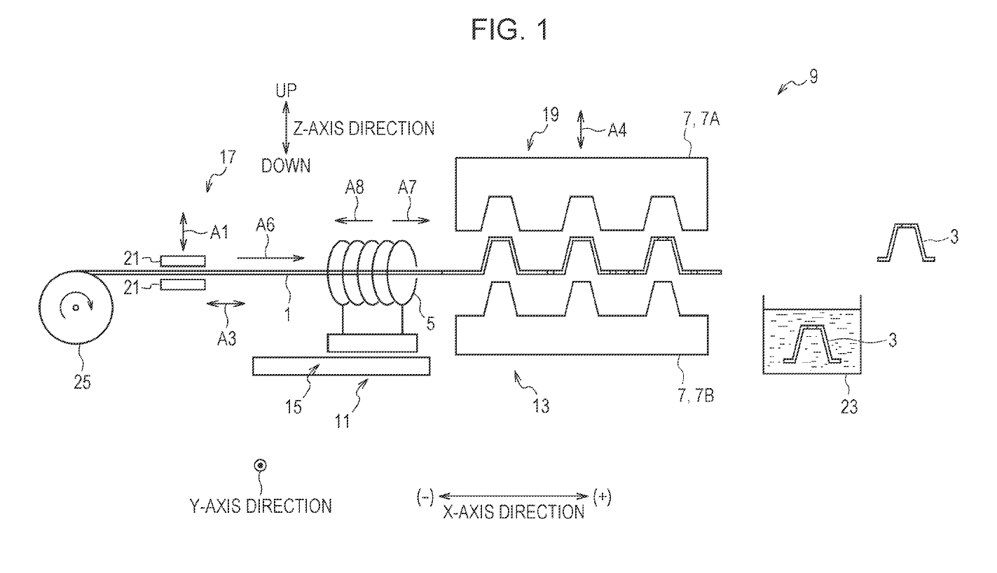

The die 7 (7A and 7B) has, for example, a plurality of (in FIG. 1, three) press stages (press sections), although it may have any suitable number of press stages. The metal strip 1 is progressively pressed in the press stages. The pitch of the press stages (the distance between the press stages that are located adjacent to each other) is constant in one embodiment, although it need not be. A feed stroke (feed amount), with which the metal strip 1 is intermittently fed at one time, coincides with the pitch.

In the press stages, pressing operations such as trimming, piercing, forming, bending, and restriking are performed. The die 7 may include a heater for preventing decrease in the temperature of the metal strip 1. The die 7 may include cooling means, such as a water passage, for decreasing the temperature of the metal strip 1.

The heating coil 5 reciprocates within a predetermined region. That is, the heating coil 5, which is disposed upstream of the die 7 in the feeding direction of the metal strip 1, reciprocates between an away-from-die position (upstream position), which is separated from the die 7 by a predetermined large distance, and an adjacent-to-die position (downstream position), which is separated from the die 7 by a predetermined small distance. The stroke of reciprocation of the heating coil 5 may be the same as the pitch of the press stages of the die 7. Alternatively, the stroke may be smaller than or larger than the pitch of the press stages.

The dimension of the heating coil 5 in the feeding direction of the metal strip 1 is, for example, sufficiently smaller than the pitch of the press stages, although it need not be.

When the metal strip feeding unit 17 is feeding the metal strip 1 and the metal strip 1 is moving, the heating coil 5 moves from the away-from-die position toward the adjacent-to-die position (in the positive X-axis direction). When the metal strip feeding unit 17 is not feeding the metal strip 1 and the metal strip 1 is not moving, the heating coil 5 moves from the adjacent-to-die position toward the away-from-die position (in the negative X-axis direction).

The moving velocity of the heating coil 5 relative to the metal strip 1 does not become “0” (except at the instant when the moving direction of the heating coil 5 changes, the moving velocity of the heating coil 5 relative to the metal strip 1 is “0”). In practice, however, this can be neglected because this is an instantaneous event. When progressive pressing is being performed, the heating coil 5 is constantly operated at a predetermined electric power irrespective of whether the metal strip 1 is moving or not moving.

When the metal strip 1 is moving, the moving velocity of the metal strip 1 is substantially constant, although when the metal strip 1 starts moving or when the metal strip 1 stops moving, the moving velocity of the metal strip 1 is not constant because acceleration occurs. In practice, however, the moving velocity of the metal strip 1 can be regarded as substantially constant, because the mass of the metal strip 1 is small and acceleration or deceleration occurs for a very short time. Likewise, the moving velocity of the heating coil 5 in the positive X-axis direction is substantially constant, and the moving velocity of the heating coil 5 in the negative X-axis direction is substantially constant.

As can be understood from the above description, when the hot pressing apparatus 9 is operating, the heating coil 5 is moved by the heating coil moving unit 15 at the first moving velocity or at the second moving velocity as described above.

That is, when the progressive pressing device 13 is feeding the metal strip 1, the heating coil 5 of the induction heating device 11 is moved at the first moving velocity in a direction the same as the moving direction of the metal strip 1. The first moving velocity is lower than the moving velocity of the metal strip 1, and the difference between the moving velocity of the metal strip 1 and the first moving velocity is substantially constant.

When the progressive pressing device 13 is not moving the metal strip 1 and the progressive pressing device 13 is press-forming a predetermined portion of the metal strip 1 using the die 7, the heating coil 5 of the induction heating device 11 is moved at the second moving velocity in a direction opposite to the moving direction of the metal strip 1 in which the metal strip 1 is moved by the progressive pressing device 13. The second moving velocity is substantially the same as the difference between the moving velocity of the metal strip 1 at which the metal strip 1 is moved by the progressive pressing device 13 and the first moving velocity.

The heating coil moving unit 15 moves the heating coil 5 using an actuator (not shown) such as, but not limited to, a servo motor.

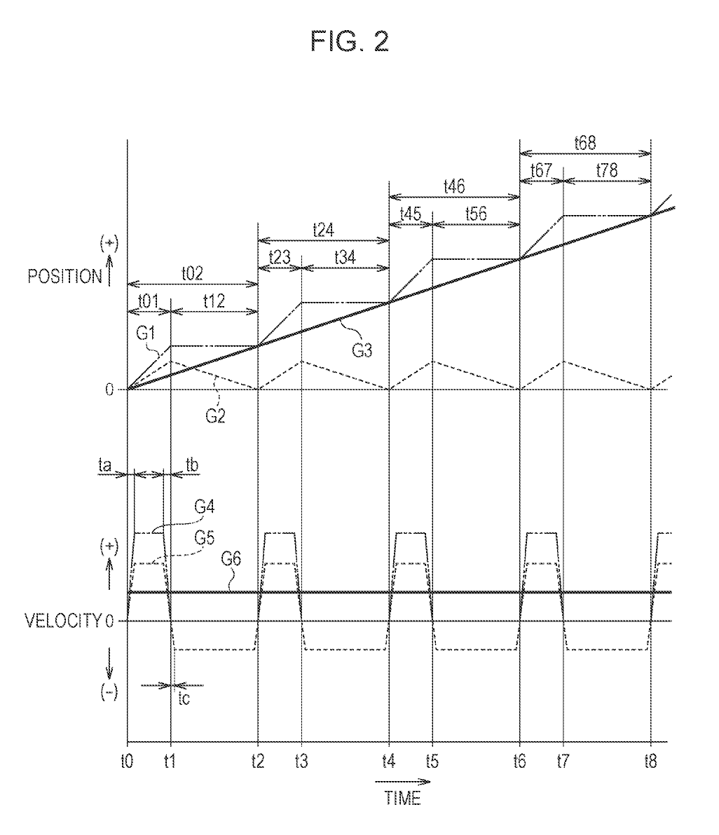

Referring to FIG. 2, the operations of the hot pressing apparatus 9 will be described in further detail. The horizontal axis of FIG. 2 represents time, and the vertical axis of FIG. 2 represents the position and the velocity of the metal strip 1 and the heating coil 5. A line G1 represents the position of the metal strip 1, a line G2 represents the position of the heating coil 5, and a line G3 represents the position of the metal strip 1 relative to the heating coil 5. A line G4 represents the velocity of the metal strip 1, a line G5 represents the velocity of the heating coil 5, and a line G6 represents the velocity of the metal strip 1 relative to the heating coil 5.

The lines G1, G2, and G3 can be respectively obtained by integrating the functions represented by the lines G4, G5, and G6 with respect to time. To be precise, each of the lines G1, G2, and G3 includes curved portions, because each of the lines G4, G5, and G6 includes acceleration and deceleration portions (in time intervals ta, tb, and tc). However, because acceleration and deceleration can be neglected as described above, each of the lines G1, G2, and G3 illustrated in FIG. 2 consists of straight lines.

The hot pressing apparatus 9 performs the following operations under the control of a control apparatus (not shown).

In an initial state, the metal strip 1 extends in the X-axis direction, the heating coil 5 is not operated and is stationary at the upstream position, and the die 7 (7A and 7B) is open and is not pressing the metal strip 1. The initial state corresponds to a time t0 in FIG. 2.

In the initial state, the metal strip 1 starts moving (in the positive X-axis direction). At the same time, the heating coil 5 starts operating (the heating coil 5 is energized). At the same time, the heating coil 5 starts moving in the positive X-axis direction at the first moving velocity. This operation is performed for a time interval t01.

At a time t1, which is the time interval t01 after the time t0, the movement of the metal strip 1 is stopped. At the same time, the heating coil 5 starts moving in the negative X-axis direction at the second moving velocity. This operation is performed for a time interval t12 until a time t2 arrives. The metal strip 1 is press-formed for the time interval t12 using the die 7.

The operation for one cycle is performed during a time interval t02, which is the sum of the time intervals t01 and t12.

Subsequently, the operation for one cycle, which is performed in the time interval t02, is repeatedly performed at a time t2, a time t4, etc.

In FIG. 2, a time interval t23 (from the time t2 to the time t3), a time interval t45 (from the time t4 to the time t5), a time interval t67 (from the time t6 to the time t7), . . . , are each the same as the time interval t01.

In FIG. 2, the time interval t34 (from the time t3 to the time t4), a time interval t56 (from the time t5 to the time t6), a time interval t78 (from the time t7 to the time t8), . . . , are each the same as the time interval t12.

Therefore, the time intervals t24, t46, t68, . . . , are each the same as the time interval t02. As can be understood from the line G6, the velocity of the metal strip 1 relative to the heating coil 5 is substantially constant.

With the method and the apparatus for manufacturing a hot pressed product 3, in order to reduce variation in the feed velocity of the metal strip 1 relative to the heating coil 5 of the induction heating device 11, the heating coil 5 of the induction heating device 11 is moved in the feeding direction of the metal strip 1 and in a direction opposite to the feeding direction of the metal strip 1. Therefore, the induction heating device 11 can heat the metal strip 1 to a uniform temperature, and the temperature of the metal strip 1 remains even or substantially even. As a result, deformation of a metal strip or feeding failure, which may occur due to uneven temperature, can be reduced or prevented; and decrease in the precision of the hot pressed product 3 formed from the metal strip 1 can be reduced or prevented.

With the method and the apparatus for manufacturing a hot pressed product 3, the maximum value of the feed velocity of the metal strip 1 relative to the heating coil 5 of the induction heating device 11 can be reduced (the difference between the velocity of the metal strip 1 and the velocity of the heating coil 5 can be reduced to, for example, a small and constant value). As a result, the metal strip 1 can be heated to a target temperature using small electric power, and the size of the induction heating device 11 can be reduced.

It is sufficient that the heating coil 5 of the induction heating device 11 reciprocate in the feeding direction of the metal strip 1 and in a direction opposite to the feeding direction of the metal strip 1 in a state in which the heating coil 5 is operated with a constant electric power. As a result, it is not necessary to control the electric power of the heating coil 5 in a complicated manner, and the size of the installation space of the heating coil 5 can be reduced.

With the method and the apparatus for manufacturing a hot pressed product 3, when the metal strip 1 is being fed, the heating coil 5 of the induction heating device 11 heats the metal strip 1 while the heating coil 5 is moved at the first moving velocity in a direction the same as the moving direction of the metal strip 1. The first moving velocity is lower than the moving velocity of the metal strip 1, and the difference between the moving velocity of the metal strip 1 and the first moving velocity is substantially constant. When the metal strip 1 is not moving, the heating coil 5 of the induction heating device 11 heats the metal strip 1 while the heating coil 5 is moved at the second moving velocity in a direction opposite to the moving direction in which the metal strip 1 is moved. The second moving velocity is substantially the same as the difference between the moving velocity of the metal strip 1 and the first moving velocity. As a result, the moving velocity of the heating coil 5 of the induction heating device 11 relative to the metal strip 1, which is intermittently fed, can be constantly and easily made generally constant, and the temperature of the metal strip 1 can be reliably prevented from becoming uneven in the longitudinal direction of the metal strip 1.

What is claimed is:

1. A method of manufacturing a hot pressed product, the method comprising:
heating a metal strip using an induction heating device;
progressively pressing the heated metal strip, and
moving a heating coil of the induction heating device in a feeding direction of the metal strip and in a direction opposite to the feeding direction of the metal strip so as to reduce variation in a feed velocity of the metal strip relative to the heating coil of the induction heating device.

2. The method of manufacturing a hot pressed product according to claim 1,
wherein, when the metal strip is being fed, the heating coil of the induction heating device heats the metal strip while moving at a first moving velocity in a direction the same as a moving direction of the metal strip, the first moving velocity being lower than a moving velocity of the metal strip, and a difference between the moving velocity of the metal strip and the first moving velocity being substantially constant, and
wherein, when the metal strip is not moving, the heating coil of the induction heating device heats the metal strip while moving at a second moving velocity in a direction opposite to the moving direction of the metal strip, the second moving velocity being substantially the same as the difference between the moving velocity of the metal strip and the first moving velocity.

3. A hot pressing apparatus comprising:
an induction heating device that heats a metal strip;
a progressive pressing device that progressively presses the metal strip; and
a heating coil moving unit that moves a heating coil of the induction heating device in a feeding direction of the metal strip and in a direction opposite to the feeding direction of the metal strip so as to reduce variation in a feed velocity of the metal strip relative to the heating coil of the induction heating device.

4. The hot pressing apparatus according to claim 3,
wherein, when the progressive pressing device is feeding the metal strip, the heating coil moving unit moves the heating coil of the induction heating device at a first moving velocity in a direction the same as a moving direction of the metal strip in which the metal strip is moved by the progressive pressing device, the first moving velocity being lower than a moving velocity of the metal strip at which the metal strip is moved by the progressive pressing device, and a difference between the moving velocity of the metal strip and the first moving velocity being substantially constant, and
wherein, when the progressive pressing device is not moving the metal strip and the progressive pressing device is press-forming the metal strip, the heating coil moving unit moves the heating coil of the induction heating device at a second moving velocity in a direction opposite to the moving direction of the metal strip, the second moving velocity being substantially the same as the difference between the moving velocity of the metal strip and the first moving velocity.
